(19) United States
(12) Patent Application Publication
(10) Pub. No.: US 2010/0045603 A1
(43) Pub. Date: Feb. 25, 2010

(54) MOUSE DEVICE FOR USE WITH COMPUTER

(75) Inventor: TING-YU WANG, Foshan (CN)

Correspondence Address: PCE INDUSTRY, INC.;ATT. Steven Reiss, 288 SOUTH MAYO AVENUE, CITY OF INDUSTRY, CA, 91789, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/346,864

(22) Filed: Dec. 31, 2008

(30) Foreign Application Priority Data
Aug. 21, 2008 (CN) 200810304128.1

(51) Int. Cl. G06F 3/033

(52) U.S. Cl. 345/163

(57) ABSTRACT

A mouse device includes two buttons, a detection circuit, and a shell. The two buttons includes a conductor and a detection circuit electrically coupled to the electrical conductor. The detection circuit is configured to detect human micro-electrical signal transmitted from the electrical conductor and for generating a corresponding pulse. The signal processing circuit is configured to receive the pulse generated by the detection circuit, and to convert the received pulse into a control signals. The shell is configured to support the buttons and house the signal processing circuit.

### BACKGROUND

1. Technical Field

The present disclosure relates to a mouse device for use with computers.

2. Description of the Related Art

Computers typically include a mouse device for controlling the motion of the cursor on a display. The mouse typically includes one or more mechanical buttons to click for selection of object(s) shown on the display. Mouse usage is coming under increasing scrutiny because while providing the computer user with considerable flexibility over the motion of the cursor, repeated clicks of the button can result in severe physical strain. This physical strain develops because, for the hand, even the smallest of postural shifts can increase or decrease stresses on the hand and fingers.

Therefore, what is desired is a mouse device that can overcome the above described problem.

### BRIEF DESCRIPTION OF THE DRAWINGS

Many aspects of the present mouse device should be better understood with reference to the accompanying drawings. The components in the drawings are not necessarily drawn to scale, the emphasis instead being placed upon clearly illustrating the principles of the mouse device. Moreover, in the drawings, like reference numerals designate corresponding parts throughout the several views.

FIG. 1 is an schematic view of a mouse device which includes a human signal detection circuit, according to an exemplary embodiment.

FIG. 2 is a functional block diagram of the human signal detection circuit of FIG. 1.

### DETAILED DESCRIPTION

Embodiments of the present mouse device will be now described in detail with reference to the drawings.

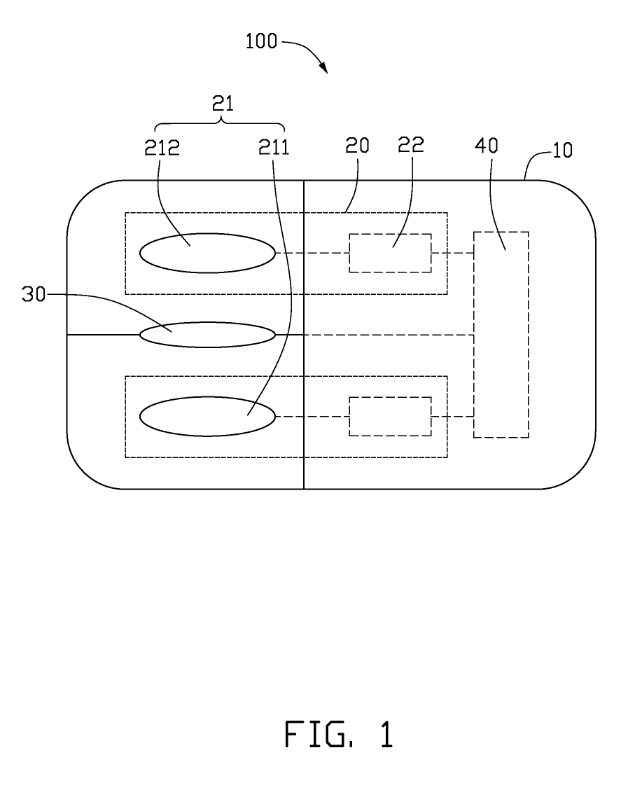

Referring to FIG. 1, a mouse device 100 in accordance with an exemplary embodiment is illustrated. The mouse device 100 includes a shell 10, two buttons 20, a scroll wheel 30, and a signal processing circuit 40. The shell 10 is configured to support the buttons 20 and house the signal processing circuit 40.

Each of the buttons 20 includes a conductor 21 and a detection circuit 22. The detection circuit 22 is electrically coupled to the conductor 21.

The conductor 21 is mounted to the shell 10 and is exposed for conducting human micro-electrical signals, when the user touches it, to a corresponding detection circuit 22. In this embodiment, the conductor 21 includes a left electrical conductor 211, and a right electrical conductor 212. It should be noted that the number of the electrical conductors 211, 212 is not limited to two, but can be any number depending on requirements.

The detection circuits 22 are electrically connected to the signal processing circuit 40. The detection circuits 22 are configured to detect whether the user touches one of the conductors 21 by detecting whether human micro-electrical signal are transmitted from one of the electrical conductors 21, and to generate a corresponding pulse. Typically, the human micro-electrical signal is a low-frequency signal.

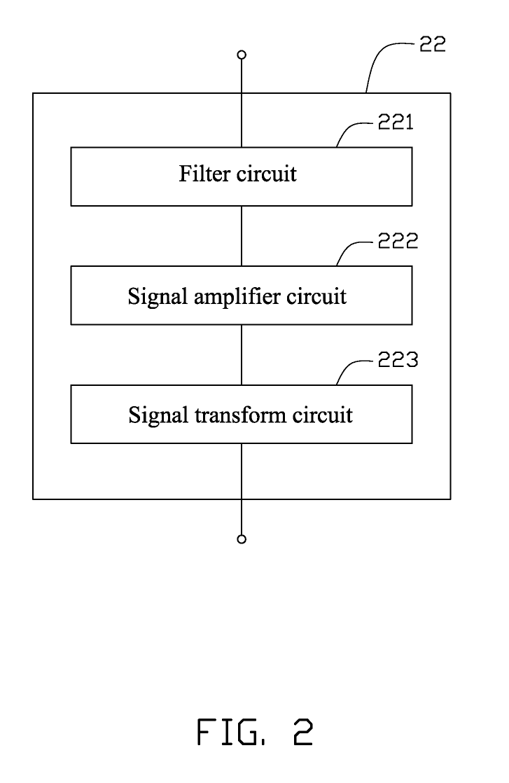

Also referring to FIG. 2, each detection circuit 22 includes a filter circuit 221, a signal amplifier circuit 222, and a signal transform circuit 223. The filter circuit 221 is electrically coupled to the electrical conductor 21, and configured to filter human micro-electrical signal transmitted from the electrical conductor 21. The signal amplifier circuit 222 is electrically interconnected between the filter circuit 221 and the signal processing circuit 40, and configured to amplify human micro-electrical signal and convert the amplified human micro-electrical signal to an square wave. The signal transform circuit 223 is electrically connected to the signal processing circuit 40, and configured to transform the square wave to a stable pulse. It should be noted that, the detection circuits 22 will generate a pulse in response to a touch of the user.

The scroll wheel 30 is disposed between the button 211 and the second button 212, and electrically coupled to the signal processing circuit 40, and is configured to generate a turn-page pulse.

The signal processing circuit 40 is configured to receive the pulses generated by the detection circuits 21 and the scroll wheel 30, and convert the received pulses into control signals to interpret touches as button clicks or wheel scroll 30.

For example, when the user touches the left button 211, the detection circuit 22 generates a pulse. The width of the generated pulse is essentially equal to the touch duration. Then the signal processing circuit 40 interprets the generated pulse into a predetermined mouse function such as a click at the position of the cursor on the computer screen based on the pulse width. For example, if the pulse is shorter than a predetermined time, the signal processing circuit 40 interprets the generated pulse into a single click at the position of the cursor. If the pulse is longer than the predetermined time, the signal processing circuit 40 interprets the generated pulse as a click and hold action at the position of the cursor. If during a predetermined period of short duration, e.g., 1 second, two human micro-electrical signals are detected and two pulses are generated and transmitted to the signal processing circuit 40, and the signal processing circuit 40 interprets the generated pulses as a double-click at the position of the cursor.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A mouse device for use in computer, comprising:
two buttons each comprising a conductor and a detection circuit electrically coupled to the conductor, the detection circuit configured to detect human micro-electrical signal transmitted from the conductor and for generating a corresponding pulse;
a signal processing circuit configured to received the pulse generated by the detection circuit, and to convert the received pulse into a control signals; and
a shell configured to support the buttons and house the signal processing circuit.

2. The mouse device as claimed in claim 1, wherein each detection circuit comprises a filter circuit, a signal amplifier circuit, and a signal transform circuit, the filter circuit is electrically connected to the conductor, and configured to filter human micro-electrical signal transmitted from the conductor, the signal amplifier circuit is electrically interconnected between the filter circuit and the signal processing circuit, and configured to amplify human micro-electrical signal and transform the amplified human micro-electrical signal into square wave, the signal transform circuit is electrically connected to the signal processing circuit, and configured to transform the square wave to a stable pulse.

3. The mouse device as claimed in claim 1, wherein the human micro-electrical signal is a low-frequency signal.

4. The mouse device as claimed in claim 2, wherein the mouse device further comprises a scroll wheel, the scroll wheel is disposed between the two conductors, and electrically coupled to the signal processing circuit, and is configured to generate turn-page pulse.

5. The mouse device as claimed in claim 1, wherein each conductor is mounted to the shell and exposed to ambient for conducting human micro-electrical signal when a user touches thereon to a corresponding human signal detection circuit.

6. A mouse device for use in computer, comprising:
a button comprising a conductor and a detection circuit electrically coupled to the conductor, the detection circuit configured to detect human micro-electrical signal transmitted from the conductor and for generating a corresponding pulse;
a signal processing circuit configured to received the pulse generated by the detection circuit, and to convert the received pulse into a control signals; and
a shell configured to support the buttons and house the signal processing circuit.

7. The mouse device as claimed in claim 6, wherein the detection circuit comprises a filter circuit, a signal amplifier circuit, and a signal transform circuit, the filter circuit is electrically connected to conductor, and configured to filter human micro-electrical signal transmitted from the conductor, the signal amplifier circuit is electrically interconnected between the filter circuit and the signal processing circuit, and configured to amplify human micro-electrical signal and transform the amplified human micro-electrical signal into square wave, the signal transform circuit is electrically connected to the signal processing circuit, and configured to transform the square wave to a stable pulse.

8. The mouse device as claimed in claim 7, wherein the mouse device further comprises a scroll wheel, the scroll wheel is disposed on the shell, and electrically coupled to the signal processing circuit, and is configured to generate turn-page pulse.
